(19) United States
(12) Patent Application Publication
(10) Pub. No.: US 2025/0104614 A1
(43) Pub. Date: Mar. 27, 2025

(54) PIXEL AND DISPLAY DEVICE INCLUDING THE SAME

(71) Applicant: Samsung Display Co., LTD., Yongin-si (KR)

(72) Inventors: KWIHYUN KIM, Yongin-si (KR); SANG YONG NO, Yongin-si (KR)

(21) Appl. No.: 18/887,386

(22) Filed: Sep. 17, 2024

(30) Foreign Application Priority Data
Sep. 27, 2023 (KR) 10-2023-0131206

(51) Int. Cl. G09G 3/32; G09G 3/3233

(52) U.S. Cl. CPC G09G 3/32; G09G 3/3233; G09G 2300/0465; G09G 2300/0819; G09G 2300/0852; G09G 2300/0861; G09G 2310/08; G09G 2320/0238; G09G 2330/021

(57) ABSTRACT

A pixel includes a light emitting element including a first electrode, and a second electrode connected to a third power line which transmits a third power voltage, a pulse width modulator which controls an emission time duration of the light emitting element in a frame period based on a data voltage, and a constant current generator which provides a driving current having a constant level to the light emitting element based on a constant current generation voltage applied thereto, where the constant current generator includes a second driving transistor including a gate electrode connected to a third node, a first electrode connected to a second power line which transmits a second power voltage, and a second electrode connected to the first electrode of the light emitting element.

This application claims priority to Korean Patent Application No. 10-2023-0131206, filed on Sep. 27, 2023, and all the benefits accruing therefrom under 35 U.S.C. § 119, the content of which in its entirety is herein incorporated by reference.

### BACKGROUND

### 1. Field

Embodiments relate to a display device. More particularly, embodiments relate to a pixel driven by a pulse width modulation scheme and a display device including the pixel.

### 2. Description of the Related Art

A display device may include a plurality of pixels, and each of the pixels may include a self-luminous element. The self-luminous element may include an organic light emitting diode, a quantum dot light emitting diode, a micro-light emitting diode, or the like.

In general, the organic light emitting diode may be driven by a pulse amplitude modulation (PAM) scheme of controlling a luminance of a light emitted from the pixel by controlling a magnitude of a driving current flowing through the organic light emitting diode.

When the micro-light emitting diode is driven by the pulse amplitude modulation scheme, a wavelength of a light emitted from the micro-light emitting diode may be shifted according to a magnitude of a driving current flowing through the micro-light emitting diode. Accordingly, the micro-light emitting diode may be driven by a pulse width modulation (PWM) scheme of controlling a luminance of a light emitted from the pixel by controlling an emission time duration of the micro-light emitting diode while maintaining the magnitude of the driving current flowing through the micro-light emitting diode constant.

### SUMMARY

Embodiments provide a pixel including a small number of transistors.

Embodiments provide a display device with a high resolution.

A pixel according to embodiments includes a light emitting element including a first electrode, and a second electrode connected to a third power line which transmit a third power voltage, a pulse width modulator which control an emission time duration of the light emitting element in a frame period based on a data voltage, and a constant current generator which provide a driving current having a constant level to the light emitting element based on a constant current generation voltage applied thereto, where the constant current generator includes a second driving transistor including a gate electrode connected to a third node, a first electrode connected to a second power line which transmit a second power voltage, and a second electrode connected to the first electrode of the light emitting element.

In an embodiment, the third power voltage may have a low voltage level in an emission period in which the light emitting element emits a light, and the third power voltage may have a third high voltage level, which is higher than the low voltage level, in at least a portion of a non-emission period in which the light emitting element does not emit the light.

In an embodiment, the second power voltage may have a second high voltage level in the emission period, and the second power voltage may have a medium voltage level, which is higher than the low voltage level and lower than the second high voltage level, in at least a portion of the non-emission period.

In an embodiment, the pulse width modulator may include a first driving transistor including a gate electrode connected to a first node, a first electrode connected to a fourth node, and a second electrode connected to a fifth node, a first write transistor including a gate electrode which receives a scan signal, a first electrode connected to a data line which transmits the data voltage, and a second electrode connected to the fourth node, a first compensation transistor including a gate electrode which receives the scan signal, a first electrode connected to the fifth node, and a second electrode connected to the first node, and a first capacitor including a first electrode which receives a sweep signal, and a second electrode connected to the first node.

In an embodiment, the third power voltage may have a third high voltage level in a turn-off period in which the light emitting element is turned off, a first initialization period in which the gate electrode of the second driving transistor is initialized, a second initialization period in which the gate electrode of the first driving transistor is initialized, a compensation period in which a threshold voltage of the second driving transistor is compensated, a first write period in which the data voltage for which a threshold voltage of the first driving transistor is compensated is written to the gate electrode of the first driving transistor, and a second write period in which the constant current generation voltage is written to the gate electrode of the second driving transistor, and the third power voltage may have a low voltage level, which is lower than the third high voltage level, in an emission period in which the light emitting element emits a light.

In an embodiment, the second power voltage may have a second high voltage level in the first initialization period, the compensation period, the first write period, the second write period, and the emission period, and the second power voltage may have a medium voltage level, which is lower than the second high voltage level and higher than the low voltage level, in the turn-off period and the second initialization period.

In an embodiment, the pulse width modulator may further include a first emission control transistor including a gate electrode which receives an emission control signal, a first electrode connected to a first power line which transmits a first power voltage, and a second electrode connected to the fourth node, and a second emission control transistor including a gate electrode which receives the emission control signal, a first electrode connected to the fifth node, and a second electrode connected to the third node.

In an embodiment, the pulse width modulator may further include an initialization transistor including a gate electrode which receives a first initialization gate signal, a first electrode which receives an initialization voltage, and a second electrode connected to the first node.

In an embodiment, each of the first write transistor, the first compensation transistor, and the initialization transistor may be an N-type transistor.

In an embodiment, the constant current generator may further include a second capacitor including a first electrode connected to the third node, and a second electrode connected to the second power line.

In an embodiment, the constant current generator may further include a second write transistor including a gate electrode which receives a write gate signal, a first electrode connected to a data line which transmits the constant current generation voltage, and a second electrode connected to a second node, a second compensation transistor including a gate electrode which receives a compensation gate signal, a first electrode connected to the second electrode of the second driving transistor, and a second electrode connected to the third node, and a third capacitor including a first electrode connected to the second node, and a second electrode connected to the third node.

In an embodiment, the second compensation transistor may be an N-type transistor.

In an embodiment, the constant current generator may further include a bypass transistor including a gate electrode which receives a second initialization gate signal, a first electrode connected to the first electrode of the light emitting element, and a second electrode connected to the second electrode of the light emitting element.

In an embodiment, the light emitting element may be a micro-light emitting diode.

A display device according to embodiments includes a display panel including a plurality of pixels, a scan driver which sequentially provides scan signals to the pixels, and a data driver which provides a data voltage and a constant current generation voltage to each of the pixels. In such embodiments, each of the pixels may include a light emitting element including a first electrode, and a second electrode connected to a third power line which transmit a third power voltage, a pulse width modulator which control an emission time duration of the light emitting element in a frame period based on the data voltage, and a constant current generator which provide a driving current having a constant level to the light emitting element based on the constant current generation voltage, where the constant current generator includes a second driving transistor including a gate electrode connected to a third node, a first electrode connected to a second power line which transmits a second power voltage, and a second electrode connected to the first electrode of the light emitting element.

In an embodiment, the third power voltage may have a low voltage level in an emission period in which the light emitting element emits a light, and the third power voltage may have a third high voltage level, which is higher than the low voltage level, in at least a portion of a non-emission period in which the light emitting element does not emit the light.

In an embodiment, the second power voltage may have a second high voltage level in the emission period, and the second power voltage has a medium voltage level, which is higher than the low voltage level and lower than the second high voltage level, in at least a portion of the non-emission period.

In an embodiment, the pulse width modulator may include a first driving transistor including a gate electrode connected to a first node, a first electrode connected to a fourth node, and a second electrode connected to a fifth node, a first write transistor including a gate electrode which receives a scan signal of the scan signals, a first electrode connected to a data line which transmits the data voltage and the constant current generation voltage, and a second electrode connected to the fourth node, a first compensation transistor including a gate electrode which receives the scan signal, a first electrode connected to the fifth node, and a second electrode connected to the first node, a first emission control transistor including a gate electrode which receives an emission control signal, a first electrode connected to a first power line which transmits a first power voltage, and a second electrode connected to the fourth node, a second emission control transistor including a gate electrode which receives the emission control signal, a first electrode connected to the fifth node, and a second electrode connected to the third node, an initialization transistor including a gate electrode which receives a first initialization gate signal, a first electrode which receives an initialization voltage, and a second electrode connected to the first node, and a first capacitor including a first electrode which receives a sweep signal, and a second electrode connected to the first node.

In an embodiment, the constant current generator may further include a second write transistor including a gate electrode which receives a write gate signal, a first electrode connected to the data line, and a second electrode connected to a second node, a second compensation transistor including a gate electrode which receives a compensation gate signal, a first electrode connected to the second electrode of the second driving transistor, and a second electrode connected to the third node, a bypass transistor including a gate electrode which receives a second initialization gate signal, a first electrode connected to the first electrode of the light emitting element, and a second electrode connected to the second electrode of the light emitting element, a second capacitor including a first electrode connected to the third node, and a second electrode connected to the second power line, and a third capacitor including a first electrode connected to the second node, and a second electrode connected to the third node.

In an embodiment, the display device may further include a power manager which commonly provides the first power voltage, the second power voltage, the third power voltage, the initialization voltage, the emission control signal, the first initialization gate signal, the second initialization gate signal, the sweep signal, the write gate signal, and the compensation gate signal to the pixels.

The constant current generator of the pixel according to embodiments may not include an emission control transistor which is turned on in response to the emission control signal, so that the number of the transistors include in the pixel may be reduced.

The display device according to embodiments may include the pixel including a small number of transistors, so that a resolution of the display device may increase.

### BRIEF DESCRIPTION OF THE DRAWINGS

Illustrative, non-limiting embodiments will be more clearly understood from the following detailed description taken in conjunction with the accompanying drawings.

FIG. 1 is a block diagram showing a display device according to an embodiment of the disclosure.

FIG. 2 is a circuit diagram showing one example of a pixel included in the display device of FIG. 1.

FIG. 3 is a view showing one example of signals and voltages provided to pixels included in the display device of FIG. 1.

FIGS. 4 to 12 are diagrams illustrating an operation of the pixel of FIG. 2.

FIG. 13 is a circuit diagram showing another example of a pixel included in the display device of FIG. 1.

FIG. 14 is a view showing another example of signals and voltages provided to pixels included in the display device of FIG. 1.

FIG. 15 is a block diagram showing a display device according to an embodiment of the disclosure.

FIG. 16 is a circuit diagram showing a pixel included in the display device of FIG. 15.

FIG. 17 is a view showing signals and voltages provided to pixels included in the display device of FIG. 15.

FIG. 18 is a block diagram showing an electronic device according to an embodiment of the disclosure.

FIG. 19 is a view showing one example in which the electronic device of FIG. 18 is implemented as a smart watch.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, a pixel and a display device according to embodiments of the disclosure will be described in greater detail with reference to the accompanying drawings.

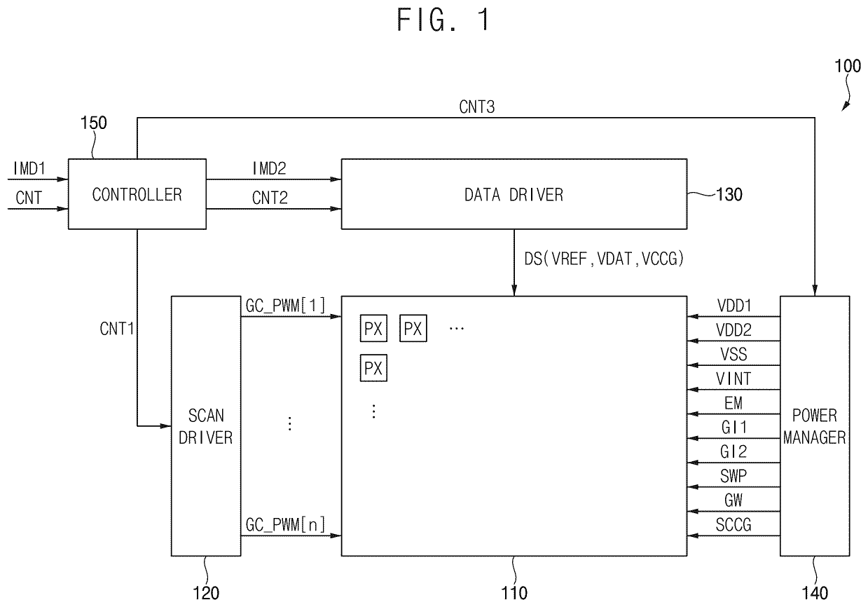

FIG. 1 is a block diagram showing a display device 100 according to an embodiment of the disclosure.

Referring to FIG. 1, an embodiment of a display device 100 may include a display panel 110, a scan driver 120, a data driver 130, a power manager 140, and a controller 150.

The display panel 110 may include pixels PX. According to an embodiment, the pixels PX may include a first pixel configured to emit a light having a first color, a second pixel configured to emit a light having a second color, and a third pixel configured to emit a light having a third color. In an embodiment, for example, the first color, the second color, and the third color may be red, green, and blue, respectively.

The scan driver 120 may sequentially provide first to n^{th} scan signals GC_PWM[1] to GC_PWM[n] (where n is a natural number that is greater than or equal to 2) to the pixels PX. The scan driver 120 may sequentially generate the first to n^{th} scan signals GC_PWM[1] to GC_PWM[n] corresponding to first to n^{th} pixel rows, respectively, based on a first control signal CNT1. The first control signal CNT1 may include a scan clock signal, a scan start signal, or the like.

The data driver 130 may provide data signals DS to the pixels PX. The data signal DS may include a reference voltage VREF, a data voltage VDAT, and a constant current generation voltage VCCG. The data driver 130 may generate first to m^{th} data signals DS (where m is a natural number that is greater than or equal to 2) corresponding to first to m^{th} pixel columns, respectively, based on second image data IMD2 and a second control signal CNT2. According to an embodiment, the second image data IMD2 may include gray level values corresponding to the pixels PX, respectively. The second control signal CNT2 may include a data clock signal, a horizontal start signal, a load signal, or the like.

In an embodiment, the power manager 140 may commonly provide a first power voltage VDD1, a second power voltage VDD2, a third power voltage VSS, an initialization voltage VINT, an emission control signal EM, a first initialization gate signal GI1, a second initialization gate signal GI2, a sweep signal SWP, a write gate signal GW, and a compensation gate signal SCCG to the pixels PX. The power manager 140 may change a voltage level of each of the first power voltage VDD1, the second power voltage VDD2, the third power voltage VSS, the initialization voltage VINT, the emission control signal EM, the first initialization gate signal GI1, the second initialization gate signal GI2, the sweep signal SWP, the write gate signal GW, and the compensation gate signal SCCG based on a third control signal CNT3.

The controller 150 may control an operation (or driving) of the scan driver 120, an operation (or driving) of the data driver 130, and an operation (or driving) of the power manager 140. The controller 150 may generate the first control signal CNT1, the second image data IMD2, the second control signal CNT2, and the third control signal CNT3 based on first image data IMD1 and a control signal CNT. According to an embodiment, the first image data IMD1 may include gray level values corresponding to the pixels PX, respectively. The controller 150 may convert the first image data IMD1 into the second image data IMD2. The control signal CNT may include a master clock signal, a vertical synchronization signal, a horizontal synchronization signal, a data enable signal, or the like.

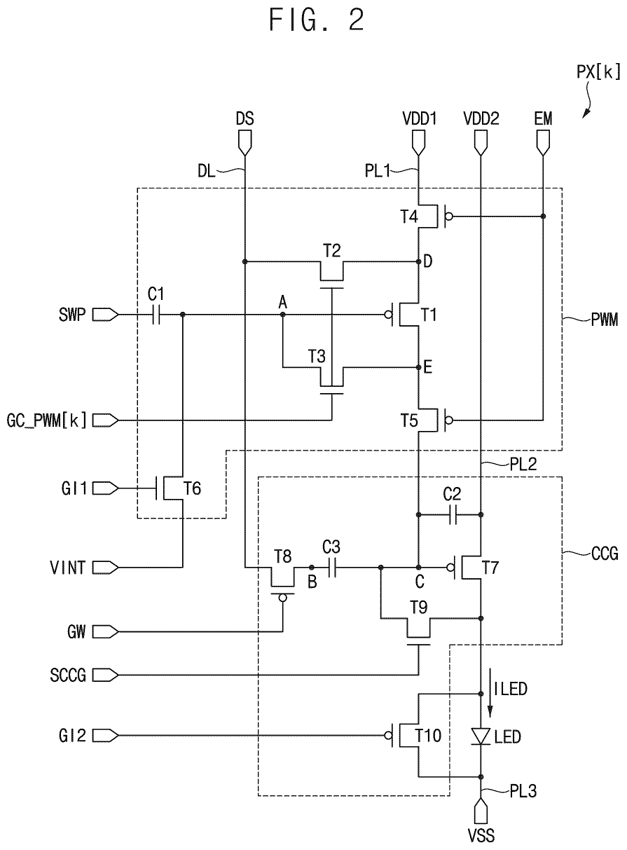

FIG. 2 is a circuit diagram showing one example of a pixel PX[k] included in the display device 100 of FIG. 1. FIG. 2 may show a pixel PX[k] included in a kth pixel row (where k is a natural number that is greater than or equal to 1, and less than or equal to n).

Referring to FIGS. 1 and 2, an embodiment of the pixel PX[k] may include a light emitting element LED, a pulse width modulator (or a pulse width modulating circuit) PWM, and a constant current generator (or a constant current generating circuit) CCG. The light emitting element LED may emit a light based on a driving current ILED. The light emitting element LED may include a first electrode, and a second electrode connected to a third power line PL3 that transmits the third power voltage VSS.

According to an embodiment, the light emitting element LED may be a micro-light emitting diode. The micro-light emitting diode may refer to an ultra-small light emitting diode having a size of about 100 micrometers (μm) or less. According to another embodiment, the light emitting element LED may be an organic light emitting diode (OLED). According to still another embodiment, the light emitting element LED may be a nano-light emitting diode (NED), a quantum dot light emitting diode, an inorganic light emitting diode, or the like.

The pulse width modulator PWM may control an emission time duration of the light emitting element LED in a frame period based on the data voltage VDAT. The pulse width modulator PWM may include a first driving transistor T1 (hereinafter referred to as a “first transistor”), a first write transistor T2 (hereinafter referred to as a “second transistor”), a first compensation transistor T3 (hereinafter referred to as a “third transistor”), a first emission control transistor T4 (hereinafter referred to as a “fourth transistor”), a second emission control transistor T5 (hereinafter referred to as a “fifth transistor”), an initialization transistor T6 (hereinafter referred to as a “sixth transistor”), and a first capacitor C1.

The constant current generator CCG may provide the driving current ILED having a constant level to the light emitting element LED based on the constant current generation voltage VCCG. The constant current generator CCG may include a second driving transistor T7 (hereinafter referred to as a “seventh transistor”), a second write transistor T8 (hereinafter referred to as an “eighth transistor”), a second compensation transistor T9 (hereinafter referred to as a “ninth transistor”), a bypass transistor T10 (hereinafter referred to as a “10^{th} transistor”), a second capacitor C2, and a third capacitor C3.

In an embodiment, as shown in FIG. 2, the first transistor T1 may include a gate electrode connected to a first node A, a first electrode connected to a fourth node D, and a second electrode connected to a fifth node E. The first transistor T1 may be turned on based on a voltage difference between the fourth node D and the first node A.

The second transistor T2 may include a gate electrode that receives a scan signal GC_PWM[k] corresponding to the pixel PX[k], a first electrode connected to a data line DL that transmits the data signal DS, and a second electrode connected to the fourth node D. The second transistor T2 may transmit the data voltage VDAT to the fourth node D in response to the scan signal GC_PWM[k] having a turn-on level, e.g., a high voltage level.

The third transistor T3 may include a gate electrode that receives the scan signal GC_PWM[k], a first electrode connected to the fifth node E, and a second electrode connected to the first node A. The third transistor T3 may connect the fifth node E to the first node A in response to the scan signal GC_PWM[k] having the high voltage level. In an embodiment, the third transistor T3 may diode-connect the first transistor T1 in response to the scan signal GC_PWM[k] having the turn-on level, e.g., the high voltage level.

The fourth transistor T4 may include a gate electrode that receives the emission control signal EM, a first electrode connected to a first power line PL1 that transmits the first power voltage VDD1, and a second electrode connected to the fourth node D. The fourth transistor T4 may transmit the first power voltage VDD1 to the fourth node D in response to the emission control signal EM having a turn-on level, e.g., a low voltage level that is lower than the high voltage level.

The fifth transistor T5 may include a first electrode connected to the fifth node E, a gate electrode that receives the emission control signal EM, and a second electrode connected to a third node C. The fifth transistor T5 may connect the fifth node E to the third node C in response to the emission control signal EM having the turn-on level, e.g., the low voltage level.

The sixth transistor T6 may include a gate electrode that receives the first initialization gate signal GI1, a first electrode that receives the initialization voltage VINT, and a second electrode connected to the first node A. The sixth transistor T6 may transmit the initialization voltage VINT to the first node A in response to the first initialization gate signal GI1 having a turn-on level, e.g., a high voltage level.

The seventh transistor T7 may include a gate electrode connected to the third node C, a first electrode connected to a second power line PL2 that transmits the second power voltage VDD2, and a second electrode connected to a first electrode of the light emitting element LED. The seventh transistor T7 may generate the driving current ILED corresponding to a difference between the second power voltage VDD2 and a voltage of the third node C.

In an embodiment, the first electrode of the seventh transistor T7 may be directly connected to the second power line PL2. In such an embodiment, another component (e.g., a transistor) may not be disposed between the first electrode of the seventh transistor T7 and the second power line PL2.

In an embodiment, the second electrode of the seventh transistor T7 may be directly connected to the first electrode of the light emitting element LED. In such an embodiment, another component (e.g., a transistor) may not be disposed between the second electrode of the seventh transistor T7 and the first electrode of the light emitting element LED.

The eighth transistor T8 may include a gate electrode that receives the write gate signal GW, a first electrode connected to the data line DL, and a second electrode connected to a second node B. The eighth transistor T8 may transmit the reference voltage VREF and the constant current generation voltage VCCG to the second node B in response to the write gate signal GW having a turn-on level, e.g., a low voltage level.

The ninth transistor T9 may include a gate electrode that receives the compensation gate signal SCCG, a first electrode connected to the second electrode of the seventh transistor T7, and a second electrode connected to the third node C. The ninth transistor T9 may connect the second electrode of the seventh transistor T7 to the third node C in response to the compensation gate signal SCCG having a turn-on level, e.g., a high voltage level. In such an embodiment, the ninth transistor T9 may diode-connect the seventh transistor T7 in response to the compensation gate signal SCCG having the turn-on level, e.g., the high voltage level.

The 10^{th} transistor T10 may include a gate electrode that receives the second initialization gate signal GI2, a first electrode connected to the first electrode of the light emitting element LED, and a second electrode connected to a second electrode of the light emitting element LED. The 10^{th} transistor T10 may transmit the third power voltage VSS to the first electrode of the light emitting element LED in response to the second initialization gate signal GI2 having a turn-on level, e.g., a low voltage level.

According to an embodiment, each of the first transistor T1, the fourth transistor T4, the fifth transistor T5, the seventh transistor T7, the eighth transistor T8, and the 10^{th} transistor T10 may be a P-type transistor (e.g., a p-channel metal-oxide-semiconductor (PMOS) transistor), and each of the second transistor T2, the third transistor T3, the sixth transistor T6, and the ninth transistor T9 may be an N-type transistor (e.g., an n-channel metal-oxide-semiconductor (NMOS) transistor). According to an embodiment, each of the first transistor T1, the fourth transistor T4, the fifth transistor T5, the seventh transistor T7, the eighth transistor T8, and the 10^{th} transistor T10 may be a polycrystalline silicon transistor, and each of the second transistor T2, the third transistor T3, the sixth transistor T6, and the ninth transistor T9 may be an oxide semiconductor transistor.

The first capacitor C1 may include a first electrode that receives the sweep signal SWP, and a second electrode connected to the first node A. The first capacitor C1 may store a voltage of the first node A.

The second capacitor C2 may include a first electrode connected to the third node C, and a second electrode connected to the second power line PL2. The second capacitor C2 may store the voltage of the third node C.

The third capacitor C3 may include a first electrode connected to the second node B, and a second electrode connected to the third node C. The third capacitor C3 may store a voltage difference between the second node B and the third node C.

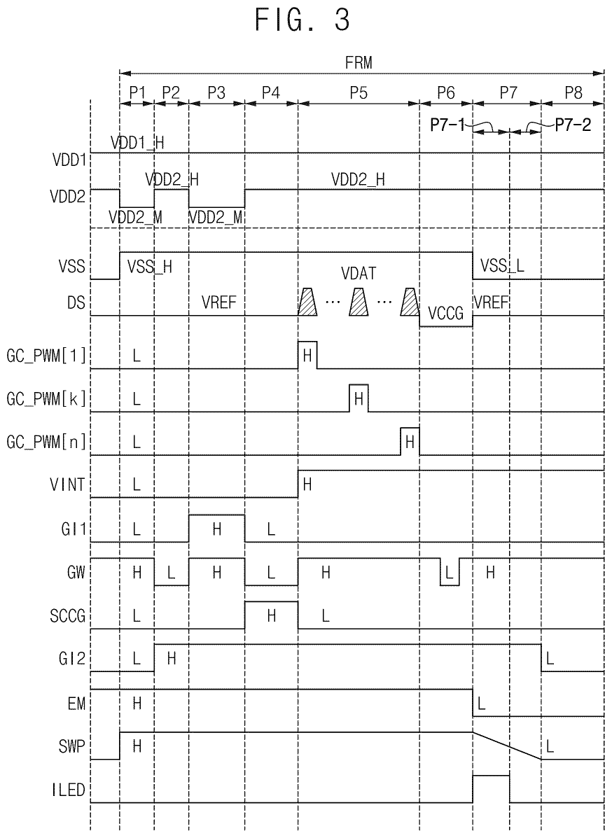

FIG. 3 is a view showing one example of signals and voltages provided to pixels PX included in the display device 100 of FIG. 1.

Referring to FIGS. 1 to 3, a frame period FRM of the display device 100 may include a turn-off period P1 (hereinafter referred to as a “first period”) in which the light emitting element LED is turned off, a first initialization period P2 (hereinafter referred to as a “second period”) in which the gate electrode of the seventh transistor T7 is initialized, a second initialization period P3 (hereinafter referred to as a “third period”) in which the gate electrode of the first transistor T1 is initialized, a compensation period P4 (hereinafter referred to as a “fourth period”) in which a threshold voltage of the seventh transistor T7 is compensated for, a first write period P5 (hereinafter referred to as a “fifth period”) in which the data voltage VDAT for which a threshold voltage of the first transistor T1 is compensated is written to the gate electrode of the first transistor T1, a second write period P6 (hereinafter referred to as a “sixth period”) in which the constant current generation voltage VCCG is written to the gate electrode of the seventh transistor T7, am emission period P7 (hereinafter referred to as a “seventh period”) in which the light emitting element LED emits a light, and a bypass period P8 (hereinafter referred to as an “eighth period”) in which the light emitting element LED displays black. The seventh period P7 may include a first seventh period P7-1 in which the driving current ILED having the constant level flows through the light emitting element LED, and a second seventh period P7-2 in which the driving current ILED does not flow through the light emitting element LED. The periods P1 to P6 and P8 except for the emission period P7 in the frame period FRM may be non-emission periods.

The first power voltage VDD1, the second power voltage VDD2, the third power voltage VSS, the initialization voltage VINT, the first initialization gate signal GI1, the write gate signal GW, the compensation gate signal SCCG, the second initialization gate signal GI2, the emission control signal EM, and the sweep signal SWP may be commonly provided to the pixels PX. According to an embodiment, the first power voltage VDD1, the second power voltage VDD2, the third power voltage VSS, the initialization voltage VINT, the first initialization gate signal GI1, the write gate signal GW, the compensation gate signal SCCG, the second initialization gate signal GI2, the emission control signal EM, and the sweep signal SWP may be substantially simultaneously applied to at least two pixel rows, e.g., first to n^{th} pixel rows. The scan signals GC_PWM[1], . . . , GC_PWM[k], . . . , and GC_PWM[n] may be sequentially provided to the pixels PX on a pixel row basis.

The first power voltage VDD1 may have a first high voltage level VDD1_H in the first to eighth periods P1 to P8.

The second power voltage VDD2 may have a second high voltage level VDD2_H in the emission period P7, and have a medium voltage level VDD2_M that is lower than the second high voltage level VDD2_H and higher than a low voltage level VSS_L of the third power voltage VSS in at least a portion of the non-emission period. According to an embodiment, the second power voltage VDD2 may have the second high voltage level VDD2_H in the second and fourth to eighth periods P2 and P4 to P8, and have the medium voltage level VDD2_M in the first and third periods P1 and P3.

The third power voltage VSS may have the low voltage level VSS_L in the emission period P7, and have a third high voltage level VSS_H in at least a portion of the non-emission period. According to an embodiment, the third power voltage VSS may have the low voltage level VSS_L in the seventh and eighth periods P7 and P8, and have the third high voltage level VSS_H in the first to sixth periods P1 to P6.

According to an embodiment, the first high voltage level VDD1_H, the second high voltage level VDD2_H, and the third high voltage level VSS_H may be equal to or different from each other.

The data signal DS may have the reference voltage VREF in the first to fourth, seventh, and eighth periods P1 to P4, P7, and P8, have the data voltage VDAT in the fifth period P5, and have the constant current generation voltage VCCG in the sixth period P6. A voltage level of the constant current generation voltage VCCG may be lower than a voltage level of the reference voltage VREF.

Each of the scan signals GC_PWM[1], . . . , GC_PWM[k], . . . , and GC_PWM[n] may have a low voltage level L in the first to fourth and sixth to eighth periods P1 to P4 and P6 to P8, and have a high voltage level H in the fifth period P5. The scan signals GC_PWM[1], . . . , GC_PWM[k], . . . , and GC_PWM[n] may be sequentially shifted by a predetermined time period (e.g., one horizontal period).

The initialization voltage VINT may have a low voltage level L in the first to fourth periods P1 to P4, and have a high voltage level H in the fifth to eighth periods P5 to P8. The first initialization gate signal GI1 may have a low voltage level L in the first, second, and fourth to eighth periods P1, P2, and P4 to P8, and have a high voltage level H in the third period P3. The write gate signal GW may have a high voltage level H in the first, third, fifth, seventh, and eighth periods P1, P3, P5, P7, and P8, and have a low voltage level L in the second, fourth, and sixth periods P2, P4, and P6. The compensation gate signal SCCG may have a low voltage level L in the first to third and fifth to eighth periods P1 to P3 and P5 to P8, and have a high voltage level H in the fourth period P4. The second initialization gate signal GI2 may have a low voltage level L in the first and eighth periods P1 and P8, and have a high voltage level H in the second to seventh periods P2 to P7. The emission control signal EM may have a high voltage level H in the first to sixth periods P1 to P6, and have a low voltage level L in the seventh and eighth periods P7 and P8. The sweep signal SWP may have a high voltage level H in the first to sixth periods P1 to P6, a voltage that linearly decreases from the high voltage level H to a low voltage level L in the seventh period P7, and the low voltage level L in the eighth period P8.

According to an embodiment, the high voltage level H of each of the scan signals GC_PWM[1], . . . , GC_PWM[k], . . . , and GC_PWM[n], the high voltage level H of the initialization voltage VINT, the high voltage level H of the first initialization gate signal GI1, the high voltage level H of the write gate signal GW, the high voltage level H of the compensation gate signal SCCG, the high voltage level H of the second initialization gate signal GI2, the high voltage level H of the emission control signal EM, and the high voltage level H of the sweep signal SWP may be equal to or different from each other. According to an embodiment, the low voltage level L of each of the scan signals GC_PWM[1], . . . , GC_PWM[k], . . . , and GC_PWM[n], the low voltage level L of the initialization voltage VINT, the low voltage level L of the first initialization gate signal GI1, the low voltage level L of the write gate signal GW, the low voltage level L of the compensation gate signal SCCG, the low voltage level L of the second initialization gate signal GI2, the low voltage level L of the emission control signal EM, and the low voltage level L of the sweep signal SWP may be equal to or different from each other.

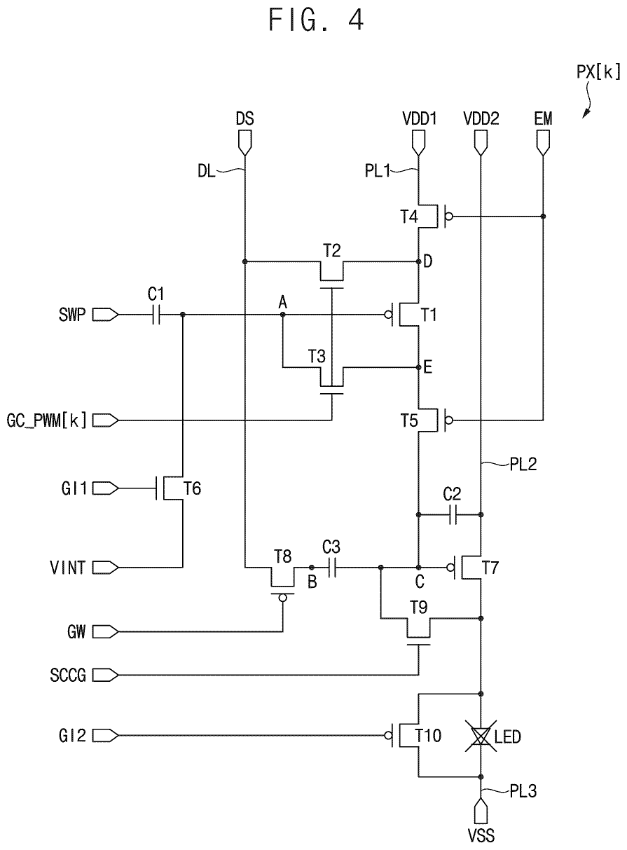

FIGS. 4 to 12 are diagrams illustrating an operation of the pixel PX[k] of FIG. 2.

Referring to FIGS. 3 and 4, in the first period P1, the second power voltage VDD2 may transition from the second high voltage level VDD2_H to the medium voltage level VDD2_M, and the third power voltage VSS may transition from the low voltage level VSS_L to the third high voltage level VSS_H. Accordingly, a voltage level of the first electrode of the light emitting element LED may be lower than a voltage level of the second electrode of the light emitting element LED, and the light emitting element LED may be turned off.

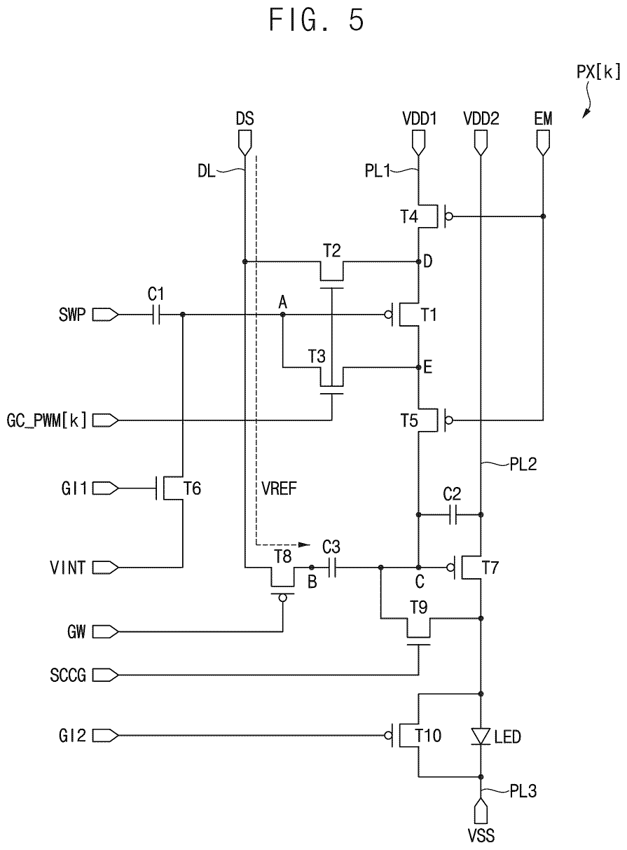

Referring to FIGS. 3 and 5, in the second period P2, the second power voltage VDD2 may transition from the medium voltage level VDD2_M to the second high voltage level VDD2_H, and the write gate signal GW may transition from the high voltage level H to the low voltage level L. Accordingly, the eighth transistor T8 may be turned on such that the reference voltage VREF may be applied to the second node B. The voltage of the third node C may be changed in response to a change in the second power voltage VDD2 and a change in a voltage of the second node B caused by coupling effects of the second capacitor C2 and the third capacitor C3. Accordingly, the gate electrode of the seventh transistor T7 may be initialized, and the seventh transistor T7 may be turned on.

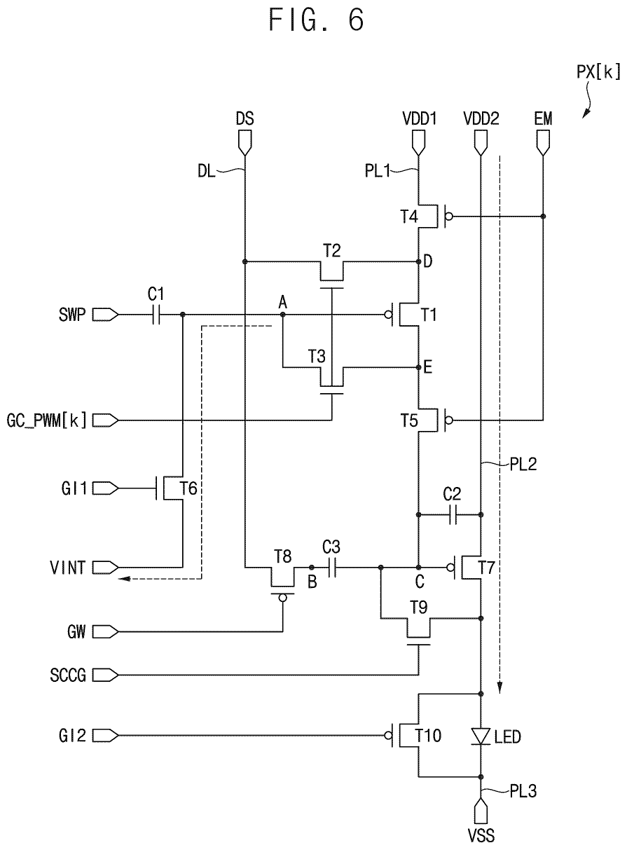

Referring to FIGS. 3 and 6, in the third period P3, the first initialization gate signal GI1 may transition from the low voltage level L to the high voltage level H. Accordingly, the sixth transistor T6 may be turned on such that the initialization voltage VINT may be applied to the first node A, the gate electrode of the first transistor T1 may be initialized, and the first transistor T1 may be turned on. In addition, the second power voltage VDD2 may transition from the second high voltage level VDD2_H to the medium voltage level VDD2_M, and the second power voltage VDD2 having the medium voltage level VDD2_M may be applied to the first electrode of the light emitting element LED through the seventh transistor T7.

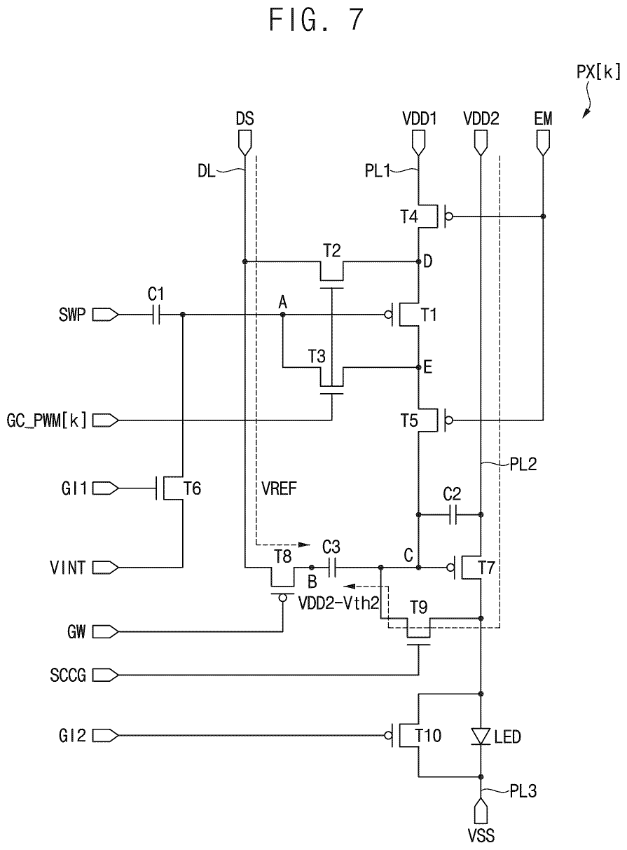

Referring to FIGS. 3 and 7, in the fourth period P4, the second power voltage VDD2 may transition from the medium voltage level VDD2_M to the second high voltage level VDD2_H, and the compensation gate signal SCCG may transition from the low voltage level L to the high voltage level H. Accordingly, the ninth transistor T9 is turned on such that a difference between the second power voltage VDD2 and a threshold voltage (Vth2) of the seventh transistor T7 may be stored in the third node C through the seventh transistor T7 and the ninth transistor T9. In the fourth period P4, the write gate signal GW may transition from the high voltage level H to the low voltage level L. Accordingly, the eighth transistor T8 may be turned on such that the reference voltage VREF may be applied to the second node B.

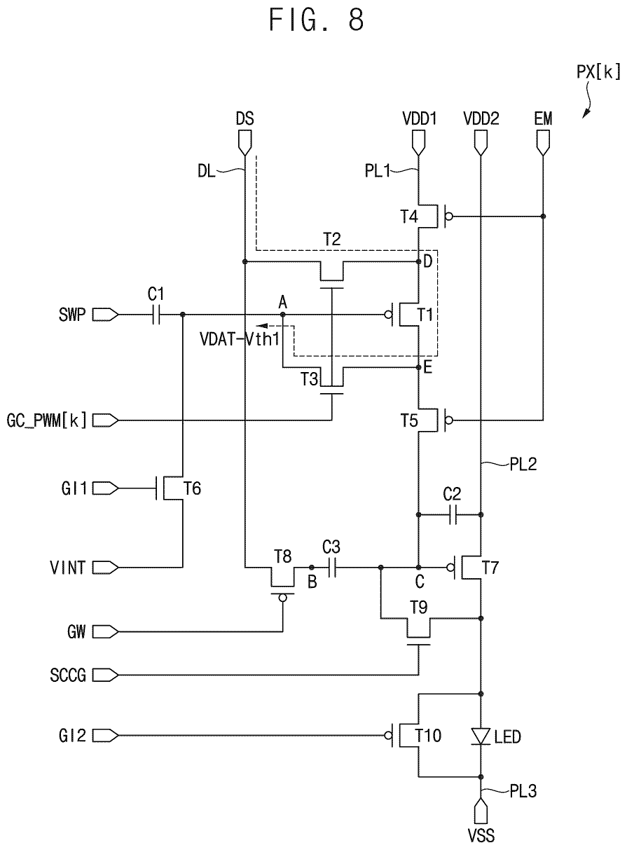

Referring to FIGS. 3 and 8, in the fifth period P5, the scan signal GC_PWM[k] may transition from the low voltage level L to the high voltage level H, and the data signal DS may have the data voltage VDAT. Accordingly, the second transistor T2 and the third transistor T3 may be turned on such that a difference between the data voltage VDAT and a threshold voltage (Vth1) of the first transistor T1 may be stored in the first node A through the second transistor T2, the first transistor T1, and the third transistor T3.

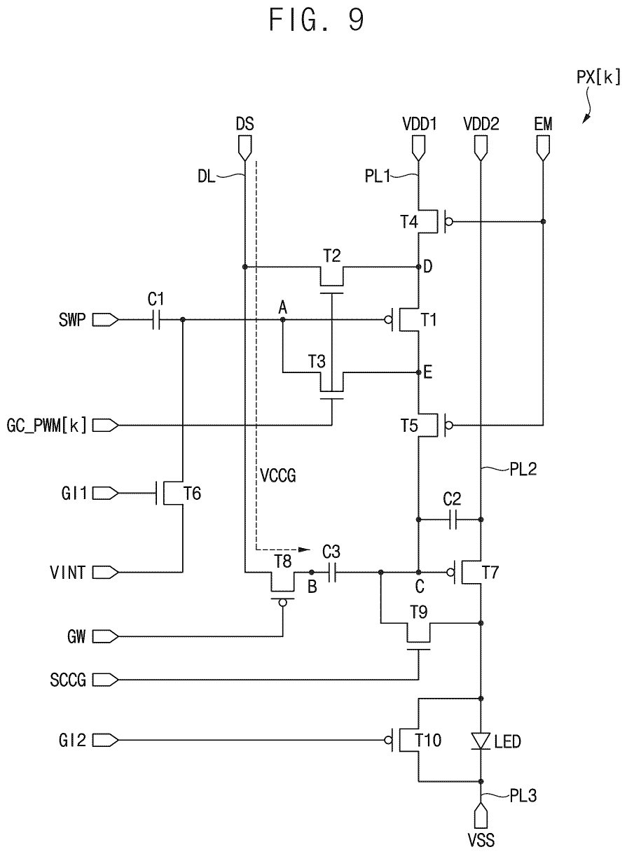

Referring to FIGS. 3 and 9, in the sixth period P6, the write gate signal GW may transition from the high voltage level H to the low voltage level L, and the data signal DS may have the constant current generation voltage VCCG. Accordingly, the eighth transistor T8 may be turned on such that the constant current generation voltage VCCG may be applied to the second node B. The voltage of the third node C may be changed in response to a change (VCCG-VREF) in the voltage of the second node B caused by the coupling effect of the third capacitor C3.

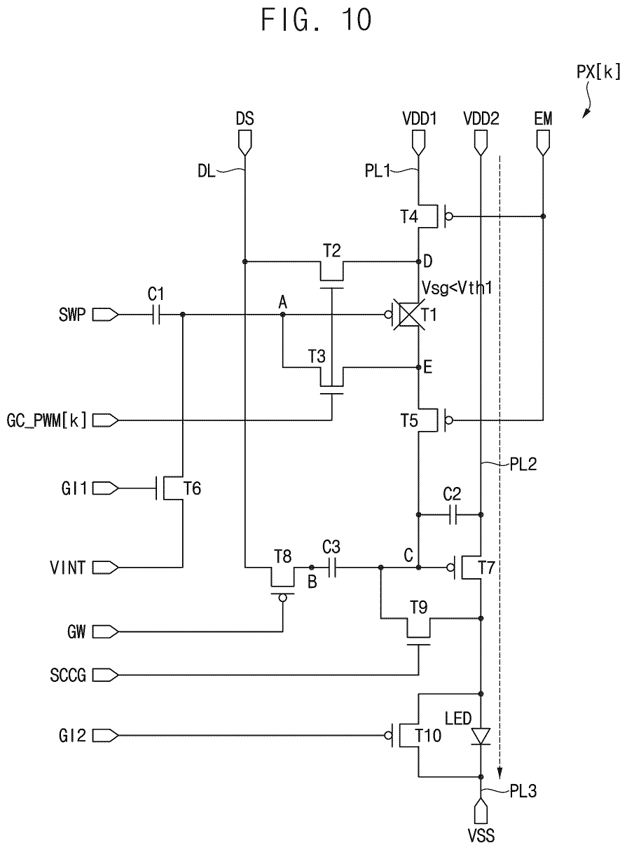

Referring to FIGS. 3 and 10, in the first seventh period P7-1, the seventh transistor T7 may generate the driving current ILED having the constant level corresponding to a voltage difference between the first electrode and the gate electrode of the seventh transistor T7 (i.e., the difference between the second power voltage VDD2 and the voltage of the third node C), and the light emitting element LED may emit the light with a luminance corresponding to the driving current ILED. In the seventh period P7, the sweep signal SWP may linearly decrease from the high voltage level H to the low voltage level L, and the emission control signal EM may transition from the high voltage level H to the low voltage level L. Accordingly, the voltage of the first node A may be decreased in response to the decrease in the sweep signal SWP caused by a coupling effect of the first capacitor C1, and the first power voltage VDD1 may be applied to the fourth node D. In the first seventh period P7-1, even when the voltage of the first node A is decreased, a voltage difference (Vsg) between the first electrode and the gate electrode of the first transistor T1 (i.e., the difference between the first power voltage VDD1 and the voltage of the first node A) may be less than the threshold voltage (Vth1) of the first transistor T1, such that the first transistor T1 may be turned off. In other words, in the first seventh period P7-1, since the voltage difference (Vsg) between the first electrode and the gate electrode of the first transistor T1 is less than the threshold voltage Vth1 of the first transistor T1, the first transistor T1 may be turned off.

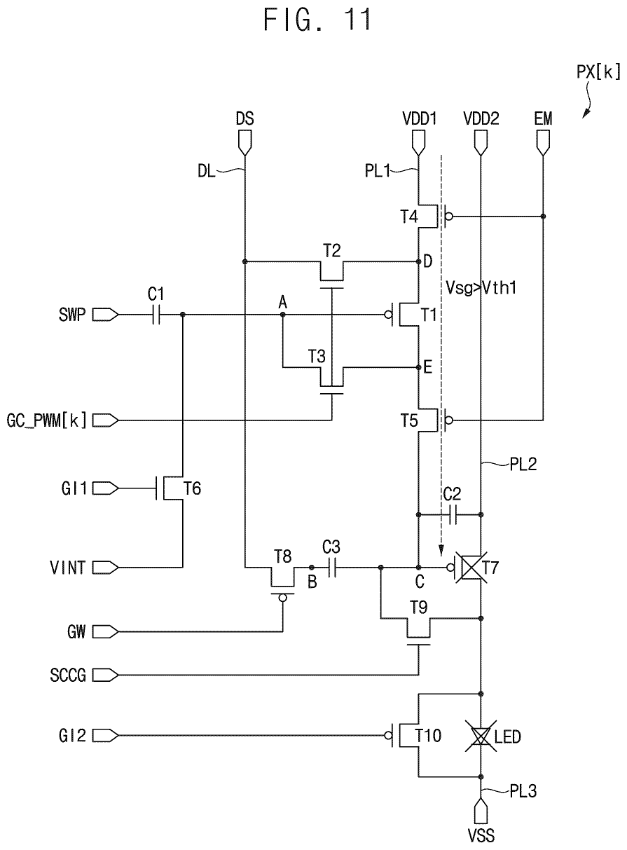

Referring to FIGS. 3 and 11, in the second seventh period P7-2, since the sweep signal SWP linearly decreases by the coupling effect of the first capacitor C1, the voltage of the first node A may be continuously decreased. Accordingly, in the second seventh period P7-2, the voltage difference (Vsg) between the first electrode and the gate electrode of the first transistor T1 (i.e., the difference between the first power voltage VDD1 and the voltage of the first node A) may be greater than the threshold voltage Vth1 of the first transistor T1, and the first transistor T1 may be turned on. In other words, in period 7-2 P7-2, since the voltage difference (Vsg) between the first electrode and the gate electrode of the first transistor T1 is greater than the threshold voltage Vth1 of the first transistor T1, the first transistor T1 may be turned on. Accordingly, the first power voltage VDD1 having the first high voltage level VDD1_H may be applied to the third node C through the fourth transistor T4, the first transistor T1, and the fifth transistor T5, and the seventh transistor T7 may be turned off. Accordingly, the seventh transistor T7 may stop generating the driving current ILED, and the light emitting element LED may not emit the light. In the seventh period P7, the driving current ILED corresponding to the constant current generation voltage VCCG may flow through the light emitting element LED for a time corresponding to the data voltage VDAT, and the light emitting element LED may emit the light with a luminance corresponding to the constant current generation voltage VCCG for the time corresponding to the data voltage VDAT. Accordingly, the luminance of the light emitted from the light emitting element LED may correspond to the emission time duration of the light emitting element LED.

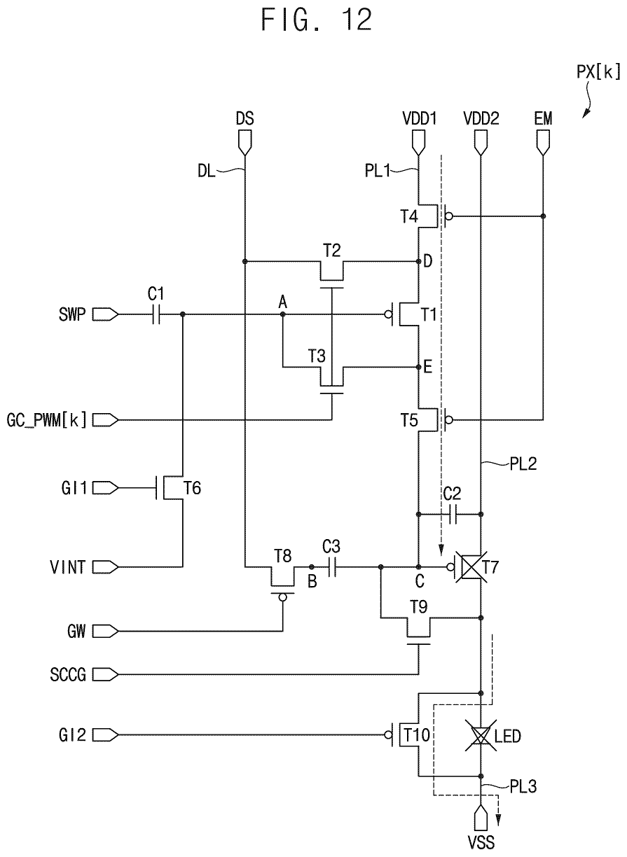

Referring to FIGS. 3 and 12, in the eighth period P8, the second initialization gate signal GI2 may transition from the high voltage level H to the low voltage level L. Accordingly, the 10^{th} transistor T10 may be turned on such that a charge charged in the first electrode of the light emitting element LED by a parasitic capacitor of the light emitting element LED may be discharged to the third power line PL3 through the 10^{th} transistor T10, and the display of the black of the light emitting element LED may be improved.

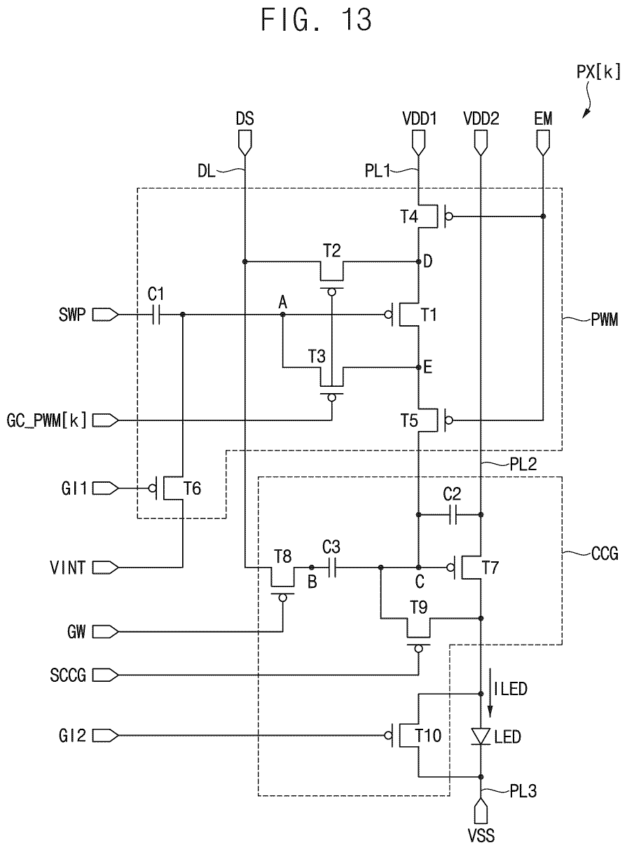

FIG. 13 is a circuit diagram showing another example of a pixel PX[k] included in the display device 100 of FIG. 1.

Referring to FIGS. 1 and 13, an embodiment of the pixel PX[k] may include a light emitting element LED, a pulse width modulator PWM, and a constant current generator CCG. In description of another example of the pixel PX[k] with reference to FIG. 13, any repetitive detailed descriptions of components that are substantially identical or similar to the components of the pixel PX[k] described above with reference to FIG. 2 will be omitted.

The second transistor T2 may include a gate electrode that receive a scan signal GC_PWM[k] corresponding to the pixel PX[k], a first electrode connected to a data line DL that transmits the data signal DS, and a second electrode connected to the fourth node D. The second transistor T2 may transmit the data voltage VDAT to the fourth node D in response to the scan signal GC_PWM[k] having a low voltage level.

The third transistor T3 may include a gate electrode that receives the scan signal GC_PWM[k], a first electrode connected to the fifth node E, and a second electrode connected to the first node A. The third transistor T3 may connect the fifth node E to the first node A in response to the scan signal GC_PWM[k] having the low voltage level.

The sixth transistor T6 may include a gate electrode that receives the first initialization gate signal GI1, a first electrode that receives the initialization voltage VINT, and a second electrode connected to the first node A. The sixth transistor T6 may transmit the initialization voltage VINT to the first node A in response to the first initialization gate signal GI1 having a low voltage level.

The ninth transistor T9 may include a gate electrode that receives the compensation gate signal SCCG, a first electrode connected to the second electrode of the seventh transistor T7, and a second electrode connected to the third node C. The ninth transistor T9 may connect the second electrode of the seventh transistor T7 to the third node C in response to the compensation gate signal SCCG having a low voltage level.

According to an embodiment, each of the first transistor T1, the second transistor T2, the third transistor T3, the fourth transistor T4, the fifth transistor T5, the sixth transistor T6, the seventh transistor T7, the eighth transistor T8, the ninth transistor T9, and the 10^{th} transistor T10 may be a P-type transistor (e.g., a PMOS transistor). According to an embodiment, each of the first transistor T1, the second transistor T2, the third transistor T3, the fourth transistor T4, the fifth transistor T5, the sixth transistor T6, the seventh transistor T7, the eighth transistor T8, the ninth transistor T9, and the 10^{th} transistor T10 may be a polycrystalline silicon transistor.

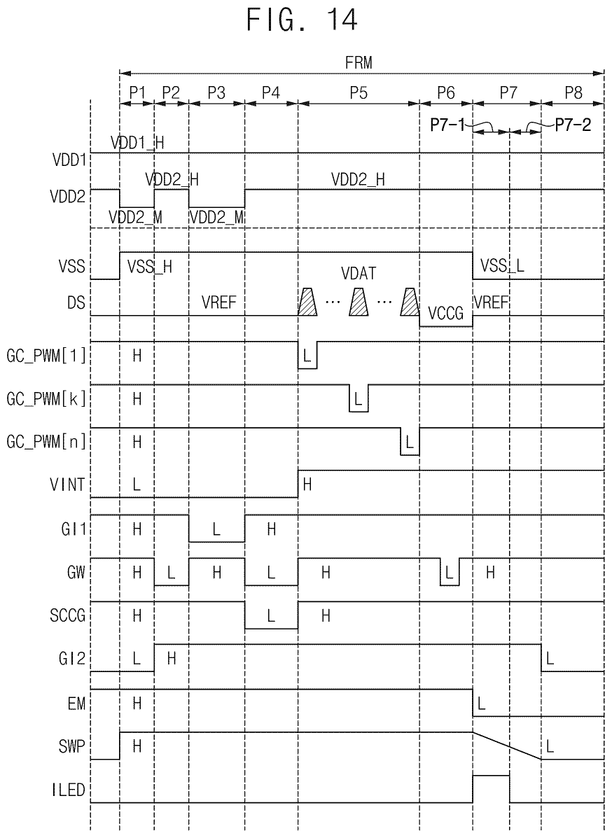

FIG. 14 is a view showing another example of signals and voltages provided to pixels PX included in the display device 100 of FIG. 1.

In description of another example of signals and voltages with reference to FIG. 14, any repetitive detailed descriptions of components that are substantially identical or similar to the components of the signals and the voltages described above with reference to FIG. 3 will be omitted.

Referring to FIGS. 1, 13, and 14, in an embodiment, each of the scan signals GC_PWM[1], . . . , GC_PWM[k], . . . , and GC_PWM[n] may have a high voltage level H in the first to fourth and sixth to eighth periods P1 to P4 and P6 to P8, and have a low voltage level L in the fifth period P5. The scan signals GC_PWM[1], . . . , GC_PWM[k], . . . , and GC_PWM[n] may be sequentially shifted by a predetermined time (e.g., one horizontal time).

The first initialization gate signal GI1 may have a high voltage level H in the first, second, and fourth to eighth periods P1, P2, and P4 to P8, and have a low voltage level L in the third period P3. The compensation gate signal SCCG may have a high voltage level H in the first to third and fifth to eighth periods P1 to P3 and P5 to P8, and have a low voltage level L in the fourth period P4.

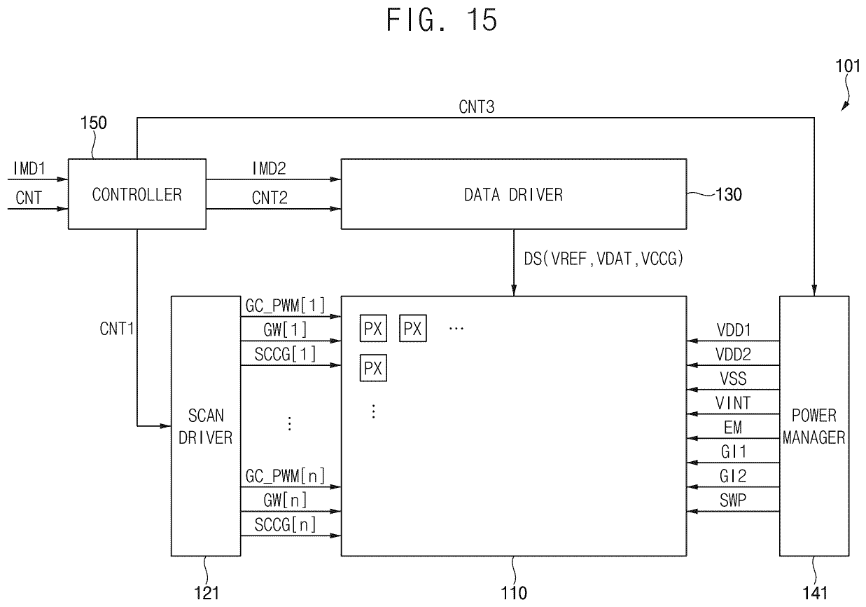

FIG. 15 is a block diagram showing a display device 101 according to an embodiment of the disclosure.

Referring to FIG. 15, an embodiment of a display device 101 may include a display panel 110, a scan driver 121, a data driver 130, a power manager 141, and a controller 150. In description of an embodiment of the display device 101 shown in FIG. 15, any repetitive detailed descriptions of components that are substantially identical or similar to the components of the display device 100 described above with reference to FIG. 1 will be omitted.

The scan driver 121 may sequentially provide first to n^{th} scan signals GC_PWM[1] to GC_PWM[n], first to n^{th} write gate signals GW[1] to GW[n], and first to n^{th} compensation gate signals SCCG[1] to SCCG[n] to the pixels PX. The scan driver 121 may sequentially generate the first to n^{th} scan signals GC_PWM[1] to GC_PWM[n], the first to n^{th} write gate signals GW[1] to GW[n], and the first to n^{th} compensation gate signals SCCG[1] to SCCG[n] corresponding to first to n^{th} pixel rows, respectively, based on a first control signal CNT1.

The power manager 141 may commonly provide a first power voltage VDD1, a second power voltage VDD2, a third power voltage VSS, an initialization voltage VINT, an emission control signal EM, a first initialization gate signal GI1, a second initialization gate signal GI2, and a sweep signal SWP to the pixels PX. The power manager 141 may change a voltage level of each of the first power voltage VDD1, the second power voltage VDD2, the third power voltage VSS, the initialization voltage VINT, the emission control signal EM, the first initialization gate signal GI1, the second initialization gate signal GI2, and the sweep signal SWP based on a third control signal CNT3.

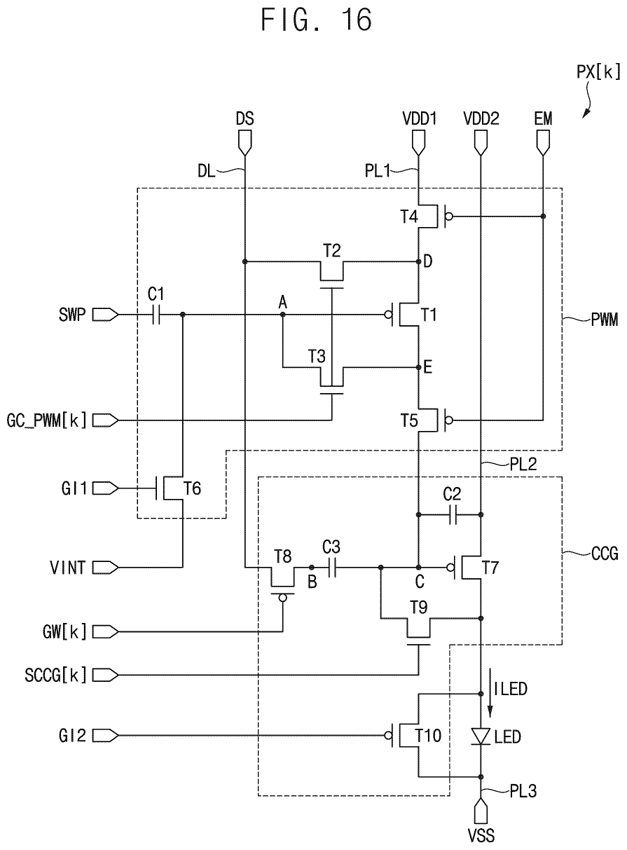

FIG. 16 is a circuit diagram showing a pixel PX[k] included in the display device 101 of FIG. 15.

Referring to FIGS. 15 and 16, an embodiment of the pixel PX[k] may include a light emitting element LED, a pulse width modulator PWM, and a constant current generator CCG. In description of an embodiment of the pixel PX[k] shown in FIG. 16, any repetitive detailed descriptions of components that are substantially identical or similar to the components of the pixel PX[k] described above with reference to FIG. 2 will be omitted.

In an embodiment, the eighth transistor T8 may include a gate electrode that receive a write gate signal GW[k] corresponding to the pixel PX[k], a first electrode connected to the data line DL, and a second electrode connected to a second node B. The eighth transistor T8 may transmit the reference voltage VREF and the constant current generation voltage VCCG to the second node B in response to the write gate signal GW[k] having a turn-on level, e.g., a low voltage level.

The ninth transistor T9 may include a gate electrode that receives a compensation gate signal SCCG[k] corresponding to the pixel PX[k], a first electrode connected to the second electrode of the seventh transistor T7 and a second electrode connected to the third node C. The ninth transistor T9 may connect the second electrode of the seventh transistor T7 to the third node C in response to the compensation gate signal SCCG[k] having a turn-on level, e.g., a high voltage level.

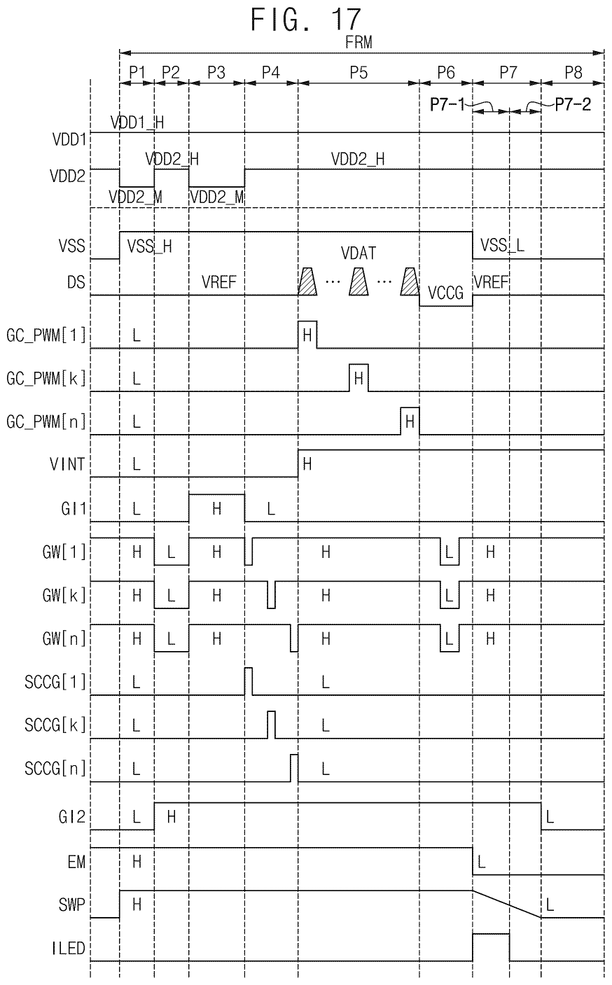

FIG. 17 is a view showing signals and voltages provided to pixels PX included in the display device 101 of FIG. 15.

In description of the signals and voltages shown in FIG. 17, any repetitive detailed descriptions of components that are substantially identical or similar to the components of the signals and the voltages described above with reference to FIG. 3 will be omitted.

In an embodiment, the first power voltage VDD1, the second power voltage VDD2, the third power voltage VSS, the initialization voltage VINT, the first initialization gate signal GI1, the second initialization gate signal GI2, the emission control signal EM, and the sweep signal SWP may be commonly provided to the pixels PX. According to an embodiment, the first power voltage VDD1, the second power voltage VDD2, the third power voltage VSS, the initialization voltage VINT, the first initialization gate signal GI1, the second initialization gate signal GI2, the emission control signal EM, and the sweep signal SWP may be substantially simultaneously applied to at least two pixel rows. The scan signals GC_PWM[1], . . . , GC_PWM[k], . . . , and GC_PWM[n], the write gate signals GW[1], . . . , GW[k], . . . , and GW[n], and the compensation gate signals SCCG[1], . . . , SCCG[k], . . . , and SCCG[n] may be sequentially provided to the pixels PX on a pixel row basis.

Each of the write gate signals GW[1], . . . , GW[k], . . . , and GW[n] may have a high voltage level H in the first, third, fifth, seventh, and eighth periods P1, P3, P5, P7, and P8, and have a low voltage level L in the second, fourth, and sixth periods P2, P4, and P6. In the fourth period P4, pulses of the write gate signals GW[1], . . . , GW[k], . . . , and GW[n] having the low voltage level L may be sequentially shifted by a predetermined time (e.g., one horizontal time).

Each of the compensation gate signals SCCG[1], . . . , SCCG[k], . . . , and SCCG[n] may have a low voltage level L in the first to third and fifth to eighth periods P1 to P3 and P5 to P8, and have a high voltage level H in the fourth period P4. The compensation gate signals SCCG[1], . . . , SCCG[k], . . . , and SCCG[n] may be sequentially shifted by a predetermined time period (e.g., one horizontal period).

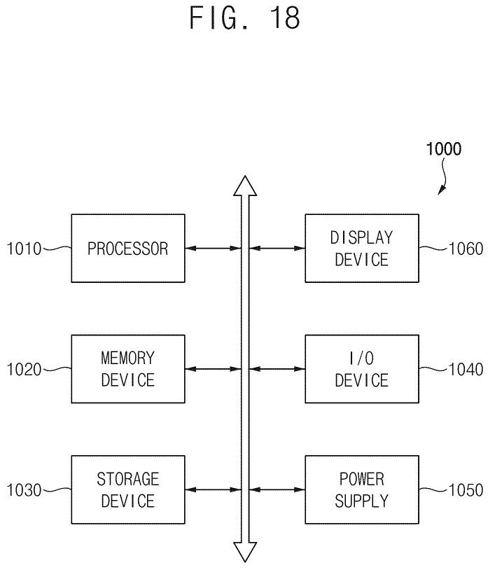

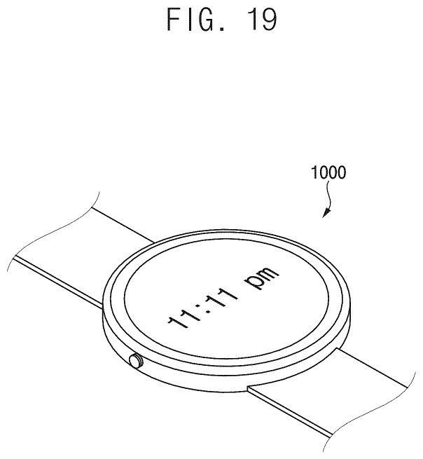

FIG. 18 is a block diagram showing an electronic device 1000 according to an embodiment of the disclosure. FIG. 19 is a view showing one example in which the electronic device 1000 of FIG. 18 is implemented as a smart watch.

Referring to FIGS. 18 and 19, an embodiment of an electronic device 1000 may include a processor 1010, a memory device 1020, a storage device 1030, an input/output (I/O) device 1040, a power supply 1050, and a display device 1060. The display device 1060 may correspond to the display device 100 of FIG. 1 or the display device 101 of FIG. 15. The electronic device 1000 may further include a plurality of ports capable of communicating with a video card, a sound card, a memory card, a USB device, or the like, or communicating with other systems.

According to an embodiment, as shown in FIG. 19, the electronic device 1000 may be implemented as a smart watch. However, the disclosure is not limited thereto, and according to another embodiment, the electronic device 1000 may be implemented as a television, a mobile phone, a video phone, a smart pad, a tablet personal computer (PC), a vehicle navigation, a laptop computer, a head-mounted display, or the like.

The processor 1010 may perform specific calculations or tasks. According to an embodiment, the processor 1010 may be a microprocessor, a central processing unit (CPU), or the like. The processor 1010 may be connected to other components through an address bus, a control bus, a data bus, or the like. According to an embodiment, the processor 1010 may also be connected to an expansion bus such as a peripheral component interconnect (PCI) bus. According to an embodiment, the processor 1010 may provide first image data (IMD1 of FIGS. 1 and 15) and a control signal (CNT of FIGS. 1 and 15) to the display device 1060.

The memory device 1020 may store data used for an operation of the electronic device 1000. In an embodiment, for example, the memory device 1020 may include: a nonvolatile memory device such as an erasable programmable read-only memory (EPROM), an electrically erasable programmable read-only memory (EEPROM), a flash memory, a phase change random access memory (PRAM), a resistance random access memory (RRAM), a nano floating gate memory (NFGM), a polymer random access memory (PoRAM), a magnetic random access memory (MRAM), or a ferroelectric random access memory (FRAM); and/or a volatile memory device such as a dynamic random access memory (DRAM), a static random access memory (SRAM), or a mobile DRAM.

The storage device 1030 may include a solid state drive (SSD), a hard disk drive (HDD), a CD-ROM, or the like. The I/O device 1040 may include: an input device such as a keyboard, a keypad, a touch pad, a touch screen, or a mouse; and an output device such as a speaker or a printer. The power supply 1050 may supply a power required for the operation of the electronic device 1000. The display device 1060 may be connected to other components through the buses or other communication links.

According to the display device 1060, a constant current generator of a pixel included in the display device 1060 may not include an emission control transistor that is turned on in response to an emission control signal, such that the number of transistors included in the pixel may be reduced. Accordingly, a resolution of the display device 1060 may be increased.

The display device according to embodiments may be applied to a display device included in a computer, a notebook, a mobile phone, a smart phone, a smart pad, a smart watch, a portable media player (PMP), a personal digital assistant (PDA), an MP3 player, or the like.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A pixel comprising:
a light emitting element including a first electrode, and a second electrode connected to a third power line which transmits a third power voltage;
a pulse width modulator which controls an emission time duration of the light emitting element in a frame period based on a data voltage; and
a constant current generator which provides a driving current having a constant level to the light emitting element based on a constant current generation voltage applied thereto, wherein the constant current generator includes a second driving transistor including a gate electrode connected to a third node, a first electrode connected to a second power line which transmits a second power voltage, and a second electrode connected to the first electrode of the light emitting element.

2. The pixel of claim 1, wherein
the third power voltage has a low voltage level in an emission period in which the light emitting element emits a light, and
the third power voltage has a third high voltage level, which is higher than the low voltage level, in at least a portion of a non-emission period in which the light emitting element does not emit the light.

3. The pixel of claim 2, wherein
the second power voltage has a second high voltage level in the emission period, and
the second power voltage has a medium voltage level which is higher than the low voltage level and lower than the second high voltage level in at least a portion of the non-emission period.

4. The pixel of claim 1, wherein the pulse width modulator includes:
a first driving transistor including a gate electrode connected to a first node, a first electrode connected to a fourth node, and a second electrode connected to a fifth node;
a first write transistor including a gate electrode which receives a scan signal, a first electrode connected to a data line which transmits the data voltage, and a second electrode connected to the fourth node;
a first compensation transistor including a gate electrode which receives the scan signal, a first electrode connected to the fifth node, and a second electrode connected to the first node; and
a first capacitor including a first electrode which receives a sweep signal, and a second electrode connected to the first node.

5. The pixel of claim 4, wherein
the third power voltage has a third high voltage level in a turn-off period in which the light emitting element is turned off, a first initialization period in which the gate electrode of the second driving transistor is initialized, a second initialization period in which the gate electrode of the first driving transistor is initialized, a compensation period in which a threshold voltage of the second driving transistor is compensated, a first write period in which the data voltage for which a threshold voltage of the first driving transistor is compensated is written to the gate electrode of the first driving transistor, and a second write period in which the constant current generation voltage is written to the gate electrode of the second driving transistor, and
the third power voltage has a low voltage level which is lower than the third high voltage level in an emission period in which the light emitting element emits a light.

6. The pixel of claim 5, wherein
the second power voltage has a second high voltage level in the first initialization period, the compensation period, the first write period, the second write period, and the emission period, and
the second power voltage has a medium voltage level, which is lower than the second high voltage level and higher than the low voltage level, in the turn-off period and the second initialization period.

7. The pixel of claim 4, wherein the pulse width modulator further includes:
a first emission control transistor including a gate electrode which receives an emission control signal, a first electrode connected to a first power line which transmits a first power voltage, and a second electrode connected to the fourth node; and
a second emission control transistor including a gate electrode which receives the emission control signal, a first electrode connected to the fifth node, and a second electrode connected to the third node.

8. The pixel of claim 7, wherein the pulse width modulator further includes an initialization transistor including a gate electrode which receives a first initialization gate signal, a first electrode which receives an initialization voltage, and a second electrode connected to the first node.

9. The pixel of claim 8, wherein each of the first write transistor, the first compensation transistor, and the initialization transistor is an N-type transistor.

10. The pixel of claim 1, wherein the constant current generator further includes a second capacitor including a first electrode connected to the third node, and a second electrode connected to the second power line.

11. The pixel of claim 10, wherein the constant current generator further includes:
a second write transistor including a gate electrode which receives a write gate signal, a first electrode connected to a data line which transmits the constant current generation voltage, and a second electrode connected to a second node;
a second compensation transistor including a gate electrode which receives a compensation gate signal, a first electrode connected to the second electrode of the second driving transistor, and a second electrode connected to the third node; and
a third capacitor including a first electrode connected to the second node, and a second electrode connected to the third node.

12. The pixel of claim 11, wherein the second compensation transistor is an N-type transistor.

13. The pixel of claim 11, wherein the constant current generator further includes a bypass transistor including a gate electrode which receives a second initialization gate signal, a first electrode connected to the first electrode of the light emitting element, and a second electrode connected to the second electrode of the light emitting element.

14. The pixel of claim 1, wherein the light emitting element is a micro-light emitting diode.

15. A display device comprising:
a display panel including a plurality of pixels;
a scan driver which sequentially provides scan signals to the pixels; and
a data driver which provides a data voltage and a constant current generation voltage to each of the pixels,
wherein each of the pixels includes:
a light emitting element including a first electrode, and a second electrode connected to a third power line which transmits a third power voltage;
a pulse width modulator which controls an emission time duration of the light emitting element in a frame period based on the data voltage; and
a constant current generator which provides a driving current having a constant level to the light emitting element based on the constant current generation voltage, wherein the constant current generator includes a second driving transistor including a gate electrode connected to a third node, a first electrode connected to a second power line which transmits a second power voltage, and a second electrode connected to the first electrode of the light emitting element.

16. The display device of claim 15, wherein
the third power voltage has a low voltage level in an emission period in which the light emitting element emits a light, and
the third power voltage has a third high voltage level, which is higher than the low voltage level, in at least a portion of a non-emission period in which the light emitting element does not emit the light.

17. The display device of claim 16, wherein
the second power voltage has a second high voltage level in the emission period, and
the second power voltage has a medium voltage level, which is higher than the low voltage level and lower than the second high voltage level, in at least a portion of the non-emission period.

18. The display device of claim 15, wherein the pulse width modulator includes:
a first driving transistor including a gate electrode connected to a first node, a first electrode connected to a fourth node, and a second electrode connected to a fifth node;
a first write transistor including a gate electrode which receives a scan signal of the scan signals, a first electrode connected to a data line which transmits the data voltage and the constant current generation voltage, and a second electrode connected to the fourth node;
a first compensation transistor including a gate electrode which receives the scan signal, a first electrode connected to the fifth node, and a second electrode connected to the first node;
a first emission control transistor including a gate electrode which receives an emission control signal, a first electrode connected to a first power line which transmits a first power voltage, and a second electrode connected to the fourth node;
a second emission control transistor including a gate electrode which receives the emission control signal, a first electrode connected to the fifth node, and a second electrode connected to the third node;
an initialization transistor including a gate electrode which receives a first initialization gate signal, a first electrode which receives an initialization voltage, and a second electrode connected to the first node; and
a first capacitor including a first electrode which receives a sweep signal, and a second electrode connected to the first node.

19. The display device of claim 18, wherein the constant current generator further includes:
a second write transistor including a gate electrode which receives a write gate signal, a first electrode connected to the data line, and a second electrode connected to a second node;
a second compensation transistor including a gate electrode which receives a compensation gate signal, a first electrode connected to the second electrode of the second driving transistor, and a second electrode connected to the third node;
a bypass transistor including a gate electrode which receives a second initialization gate signal, a first electrode connected to the first electrode of the light emitting element, and a second electrode connected to the second electrode of the light emitting element;
a second capacitor including a first electrode connected to the third node, and a second electrode connected to the second power line; and
a third capacitor including a first electrode connected to the second node, and a second electrode connected to the third node.

20. The display device of claim 19, further comprising:
a power manager which commonly provides the first power voltage, the second power voltage, the third power voltage, the initialization voltage, the emission control signal, the first initialization gate signal, the second initialization gate signal, the sweep signal, the write gate signal, and the compensation gate signal to the pixels.
